(19) United States
(12) Patent Application Publication
(10) Pub. No.: US 2010/0331062 A1
(43) Pub. Date: Dec. 30, 2010

(54) Microslide

(75) Inventors: Claus Allan Christensen, Kobenhavn S (DK); Aaron Moss, London (GB); Evalena Sandberg, London (GB); Alasdair McPhail, London (GB); Claus Hersum Jorgensen, Frederiksberg (DK); Joakim Christoffersson, Malmo (SE); Christian Rossing Kraft, Frederiksburg (DK); Michael McKay, Frederiksburg (DK); Nikolaj Bestle, Calabasas, CA (US); Morten Saxbol, Dragor (DK)

Correspondence Address: Perman & Green, LLP, 99 Hawley Lane, Stratford, CT, 06614, US

(73) Assignee: NOKIA CORPORATION, Espoo (FI)

(21) Appl. No.: 12/494,518

(22) Filed: Jun. 30, 2009

(51) Int. Cl. H04M 1/02

(52) U.S. Cl. 455/575.4

(57) ABSTRACT

An apparatus includes a device body and a movable element slidingly engaged with the device body, the movable element being movable in a longitudinal direction between an open position and a closed position relative to the device body, wherein moving the movable element from the closed position to the open position engages an active state of the apparatus.

### BACKGROUND

1. Field

The aspects of the disclosed embodiments generally relate to portable communication devices and in particular to a sliding mechanism for unlocking a portable communication device.

2. Brief Description of Related Developments

The typical monoblock or touchscreen device, such as a phone, generally requires the activation or manipulation of a key lock/unlock mechanism(s) in order to lock and unlock the device. In some cases, a sequence of keys needs to be activated within a predetermined period of time in order to unlock the device. For example, it is common to first have to press the “Unlock” soft key, and then, in order, the “Function” key, within a predetermined time period, in order to unlock a device's keypad. This can be cumbersome under certain conditions, such as for example when lighting is poor or the user is attempting one-handed operation of the device. Also, it is not always possible to determine if the device is in a locked or unlocked state without a close examination of the display or the manipulation of the keys of the device.

Similarly, call handling, such as answering an incoming call, is typically done by pressing a key on the keypad of the device. Unlike a “flip” phone, where “opening” the phone can be sufficient to execute answer a call, in a monoblock phone these actions can require a great deal of user attention, and can be difficult to exercise in limited lighting conditions.

It can also be cumbersome to manipulate the lowest row of keys on a keypad of a monoblock device, particularly while maintaining the phone with one hand. The long downward reach of the thumb for example, while trying to hold and manipulate the phone with one hand, can shift the weight balance of the phone. This can make it difficult to hold and manipulate the phone in one hand.

It would be advantageous to be able to provide an easy and efficient way to enable call handling and locking/unlocking of a monoblock device. Accordingly, it would be desirable to provide a system that addresses at least some of the problems identified above.

### SUMMARY

The aspects of the disclosed embodiments are directed to at least an apparatus. In one embodiment the apparatus includes a device body and a movable element movably engaged with the device body, the movable element being movable in a longitudinal direction between an open position and a closed position relative to the device body, wherein moving the movable element from the closed position to the open position engages an active state of the apparatus.

### BRIEF DESCRIPTION OF THE DRAWINGS

The foregoing aspects and other features of the embodiments are explained in the following description, taken in connection with the accompanying drawings, wherein:

FIG. 1 is a block diagram of a system incorporating aspects of the disclosed embodiments;

FIGS. 2A-2C are perspective view of exemplary monoblock devices incorporating aspects of the disclosed embodiments;

FIG. 3 is a perspective view the assembly of a monoblock device incorporating aspects of the disclosed embodiments;

FIG. 4A-4B are illustrations of exemplary devices that can be used to practice aspects of the disclosed embodiments;

FIG. 5 illustrates a block diagram of an exemplary system incorporating features that may be used to practice aspects of the disclosed embodiments;

FIG. 6 is a block diagram illustrating the general architecture of an exemplary system in which the devices of FIGS. 2A-2C and 4A-4B may be used;

FIGS. 7A and 7B illustrate another exemplary device incorporating aspects of the disclosed embodiments;

FIGS. 8A-8C illustrate examples of a movable element according to the disclosed embodiments;

FIG. 9 illustrates an exploded view of a device incorporating features of the disclosed embodiments;

FIGS. 10A and 10B illustrate an exemplary retaining mechanism for use in a device incorporating aspects of the disclosed embodiments; and

FIGS. 11A and 11B illustrate another example of a retaining mechanism for use in a device incorporating aspects of the disclosed embodiments.

### DETAILED DESCRIPTION OF THE EMBODIMENT(S)

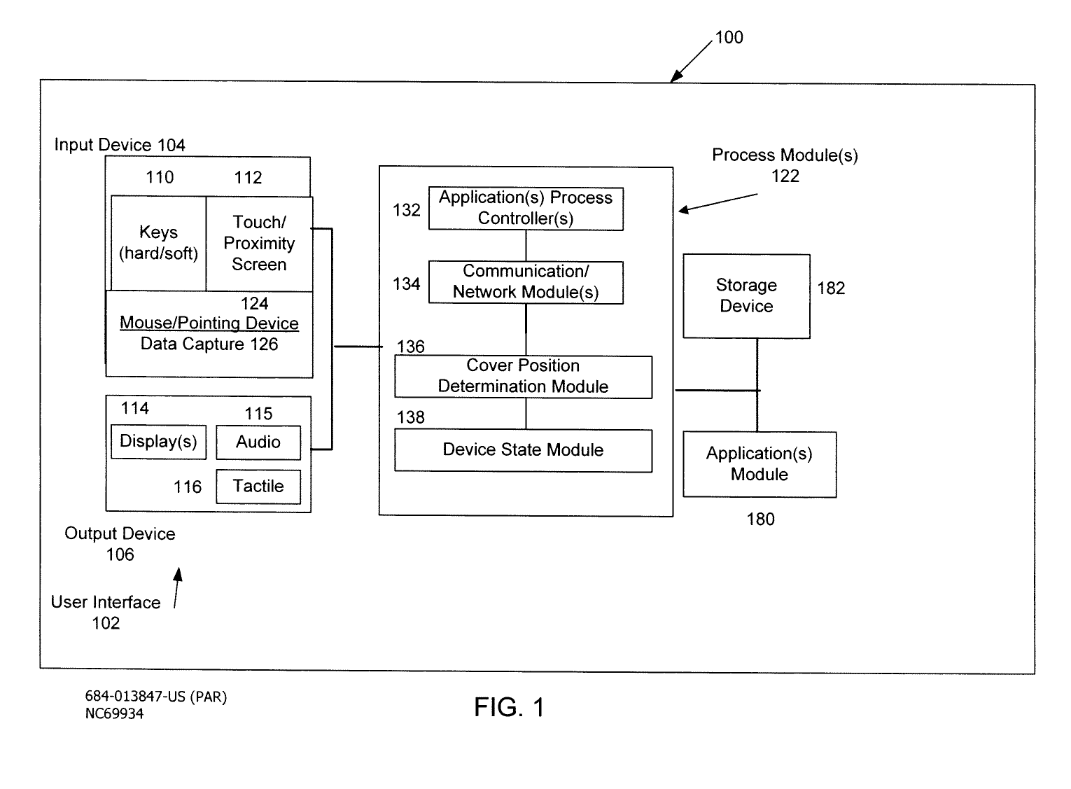

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments provide a monoblock device with at least one movable or sliding element that can be used to unlock and lock the device, as well as for call handling. Examples of movable elements can include, but are not limited to, the back cover of the device, the screen, keypad or keymat, or a combination thereof. In alternate embodiments, any suitable element of the device can be used that allows for a short movement of the element. The movement of the element can be associated with one or more of unlocking/locking the device functions, answering and ending calls or other messaging communications, and positioning the keys for better usability. For exemplary purposes of the description herein, the aspects of the disclosed embodiments will be described with respect to a back cover of the device.

By moving or sliding the back-cover a small distance, the device can be transitioned between inactive and active states. These states can include for example, key locking or call handling. The physical action of moving or sliding the back cover provides a easy, straightforward and effective way to manipulate a monoblock device, which previously was only found in slide, flip or fold style devices. By allowing the back cover of the device to move between two positions, the transformation from a closed or inactive state to an open or active state can be accomplished quickly and with one hand. The state of the device is easily identified by the position of the back cover with respect to the main body of the device. In alternate embodiments, the moveable element can also be used to activate or execute other functions of the device, other than including call handling and locking/unlocking functions. Other functions could include launching applications, accessing specific or designated functions as well as confirming actions. For example, when listening to music, repositioning the movable element, such as from the open to closed to open, or closed to open to closed position, within a certain time period, such as for example 1-2 seconds, could cause the device to advance to a next song. Similarly, if reading a document, the action of the movable element could cause the device to advance to a next page. When reading messages, the action of the movable element can cause the device to open the next message. With respect to applications, the action of the movable element could cause a selected application to launch as opposed to having to press a specific button on the device. This could be advantageous during one handed operation of the device. As another example, preference settings of the device could be used to apply one or more corresponding functions to the action of the movable element as is described herein.

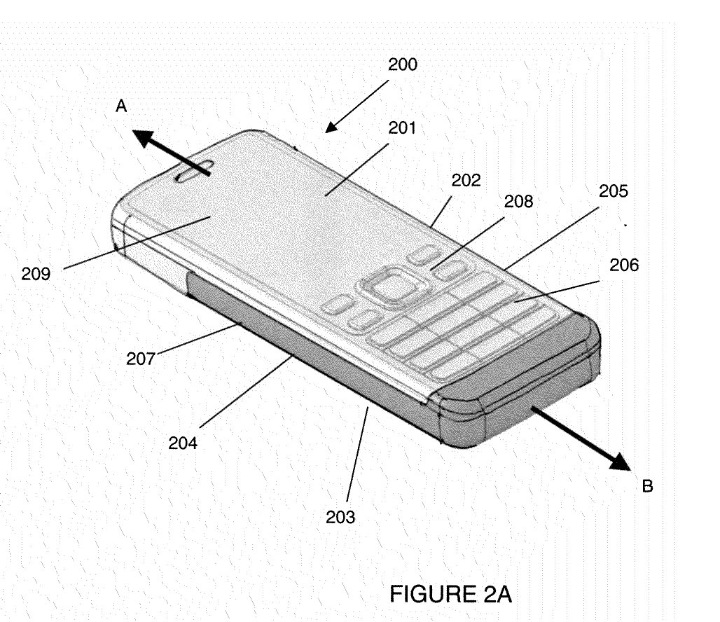

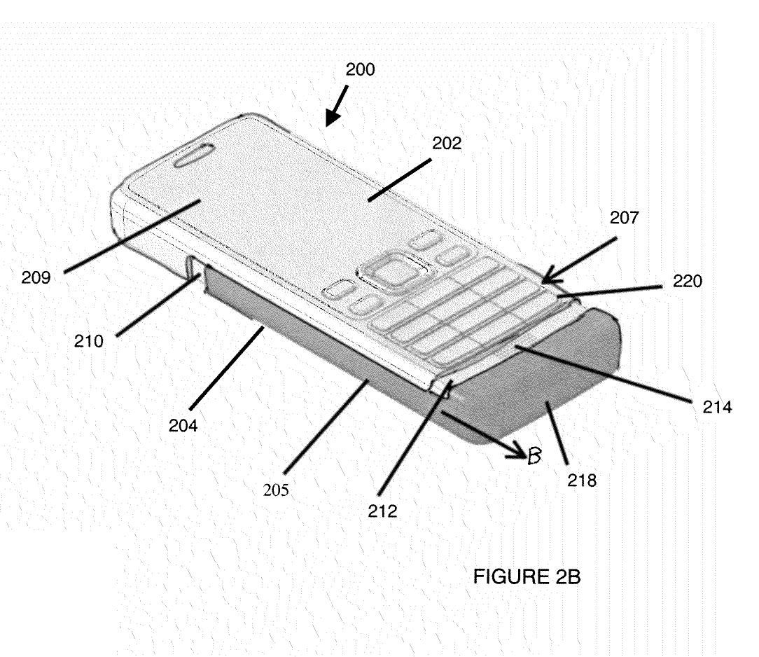

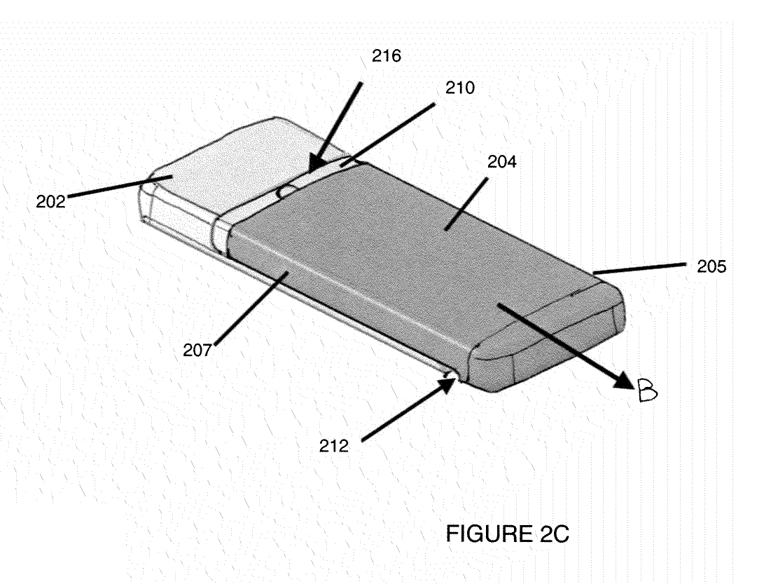

FIGS. 2A-2C illustrates one example of a monoblock device 200 incorporating aspects of the disclosed embodiments. Although the aspects of the disclosed embodiments will generally be described with respect to mobile communication devices, in alternate embodiments, the aspects of the disclosed embodiments can be applied to any mobile style device that can be locked and unlocked, such as for example, but not limited to, a portable gaming device, music or camera device.

As shown in FIG. 2A, the monoblock device 200 includes a main body 202 and a back cover 204. A top surface 201 of the main body 202 can include for example, a keypad 206, a multifunction scroll device 208 and a display 209. In alternate embodiments, the main body 202 can include any suitable components related to or for the functioning of the device 200, including for example, an antenna, speaker, microphone, camera and other components.

The back cover 204 is generally used to cover and protect certain components of the device 200 that are accessible from the back surface 203. Some of these components can include for example, but are not limited to, the printed circuit board or controller, the SIM card and the battery. In prior art devices the back cover of the device is generally removable so as to be able to access the removable or replaceable components, such as the SIM card or battery. Generally, the back cover 204 is secured to the device by a releasable locking mechanism. However, the back cover of prior art device is generally not configured to move or slide easily, unless an unlocking mechanism is activated, in which case the back cover is typically removed or disengaged from the device.

In the embodiments disclosed herein, the back cover 204 is movable with respect to the main body 202 and the initial movement as described herein does not cause the back cover 204 to become disengaged or separated from the main body 202. In one embodiment, the back cover 204 is configured to move linearly in a longitudinal direction with respect to the main body 202. The movement in essence “slides” the back cover 204 between a closed state as shown in FIG. 2A and an open state as shown in FIG. 2B. The closed state, as will be described herein, generally represents a “locked” or “inactive” state of the device 200, as that term will generally be known and understood, or otherwise defined by the manufacturer or operator of the device 200. The open state generally represents the “unlocked” and/or active state of the device 200. In alternate embodiments, the states of the device 200 that correspond to the different position of the back cover 204 relative to the main body 202 can be pre-defined in a settings or preferences menu of the device 200.

In one embodiment, in the open state, the position of the back cover 204 relative to the main body 202 generally extends the overall length of the device 200, and also exposes at least areas 210 and 214 of the main body, also referred to as gaps or openings, between respective corresponding edge portions of the main body 202 and the back cover 204. In one embodiment, the sliding motion of the back cover 204 with respect to the main body 202 is bi-stable, meaning that the back cover 204 is either in the open or closed position and the device 200 is either in the open state or the closed state.

As shown in FIGS. 2A and 2B, the back cover 204 engages the main body 202 along each of the lateral sides 205, 207. A sliding mechanism allows the back cover 204 to be slidingly moved with respect to the main body 202 between the closed position shown in FIG. 2A, and the open position as shown in FIG. 2B. In one embodiment, the sliding mechanism comprises a mechanical spring or magnetic device. The movement range of the back cover 204 can be limited by a suitable stop device so as to only allow the back cover 204 to be moved between the closed and open positions. In one embodiment, the movement distance can be in the range of approximately 4 to 12 millimeters, although in alternate embodiments, any suitable movement distance can be used. The movement range will generally be such that the movement, or change of position is tactically and visibly perceptible to the user.

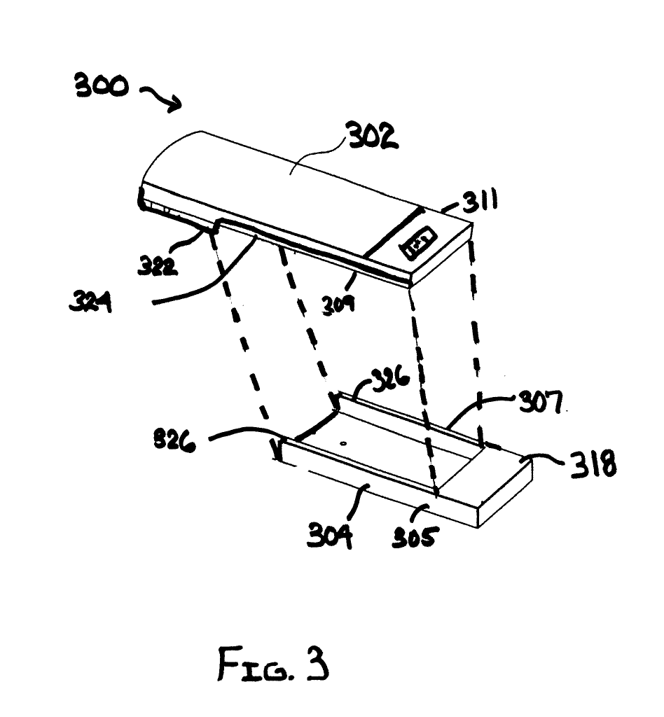

Referring to FIG. 3, in one embodiment, a switch 322 can be used to detect the relative position of the main body 302 with respect to the back cover 304. FIG. 3 generally illustrates one example of the main body 302 separated from the back cover 304 of device 300. The switch 322, which in one embodiment, is internal to the main body 302, can be coupled to the electronics of the device 300 in order to enable the device 300 to determine whether the device 300 should be in the closed or open state. In one embodiment, the switch 322 could also be located in the back cover 304 and be configured to generate a signal depending on the position of the back cover 304 relative to the main body. The switch 322 can comprise any suitable type of switch that can be used to detect a position of the back cover 304 relative to the main body 302, and can include for example a mechanical, optical, magnetic or electronic switch or switching mechanism. The use of switch 322 eliminates the need for the back cover 304 and main body 302 to be electrically connected.

FIG. 3 also illustrates one example of the sliding engagement of the back cover 304 with the main body 302. A protruding arm or member 326 extends along each side member 305, 307 of the back cover 302. Each member 326 slidingly engages a corresponding recess or groove 324 in the main body 302. A mechanical spring or other position retention device can be used to releasingly retain the back cover 304 and main body 302 in each of the open or closed position, respectively, as well as allow movement from the one position to the other. For example, in one embodiment, the position retention device can comprise a detent that engages at least a complementary portion of the member 326 as the back cover 304 is moved or repositioned relative to the main body 302.

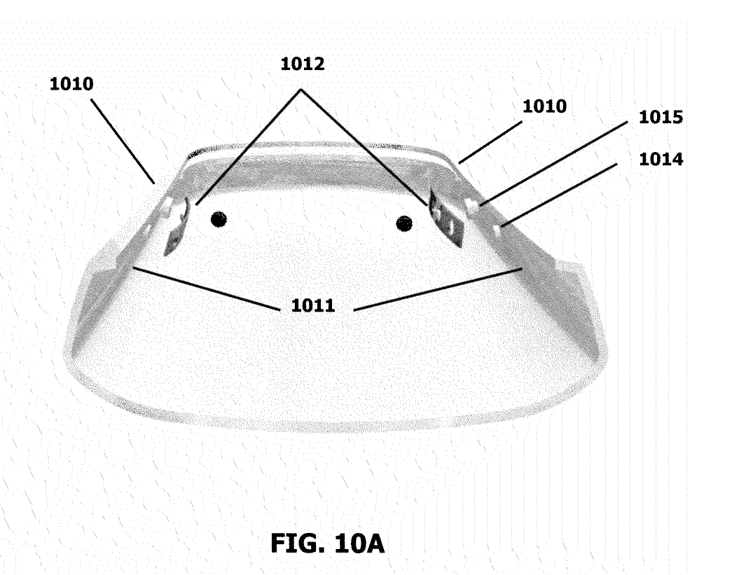

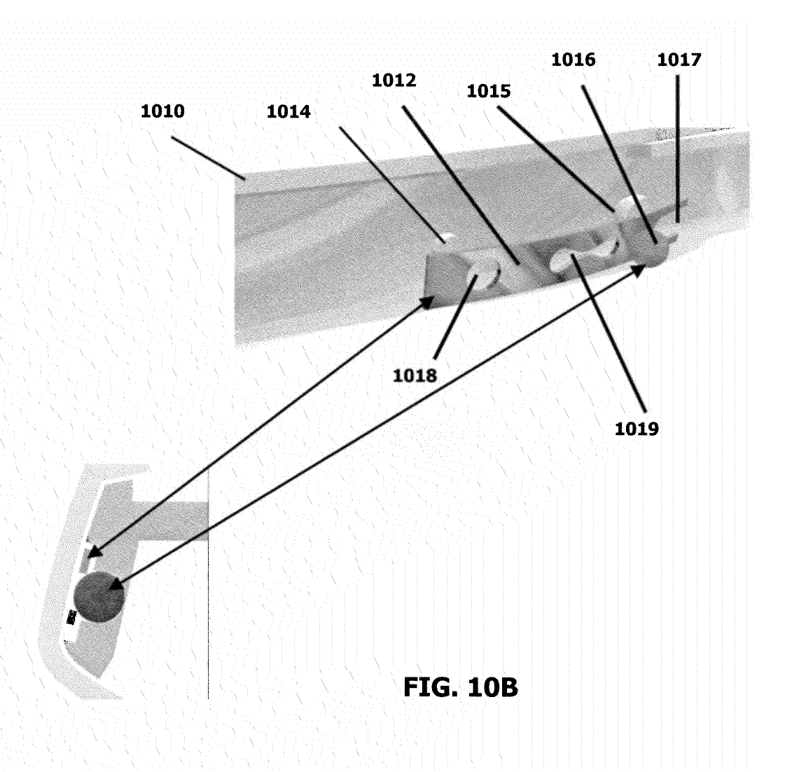

FIGS. 10A and 10B illustrate one example of a mechanism that can be used to provide the sliding and retention actions described herein. In embodiment, a bi-stable spring 1012 is positioned between the back cover 204 and main body 202 of the device 200 shown in FIG. 2A. In one embodiment, the bi-stable spring 1012 comprises a leaf spring that is secured to each inner side 1011 of the cover portion 1010. A first post member 1014, such as a stud, engages a corresponding opening 1018 or slot in the bi-stable spring 1012. A second post member 1015 engages a corresponding opening 1017 on the bi-stable spring element 1012. The first and second post members 1014, 1015 can be used to secure the bi-stable element 1012 to the cover portion 1010. A spherical member 1016, such as for example, a steel ball, can be rotatably secured between the cover portion 1010 and the bi-stable element 1012. A slotted portion 1019 in the bi-stable element 1012 allows the spherical element to releasingly engage the complementary cover portion and allow one cover portion to move with respect to the other cover portion as described herein.

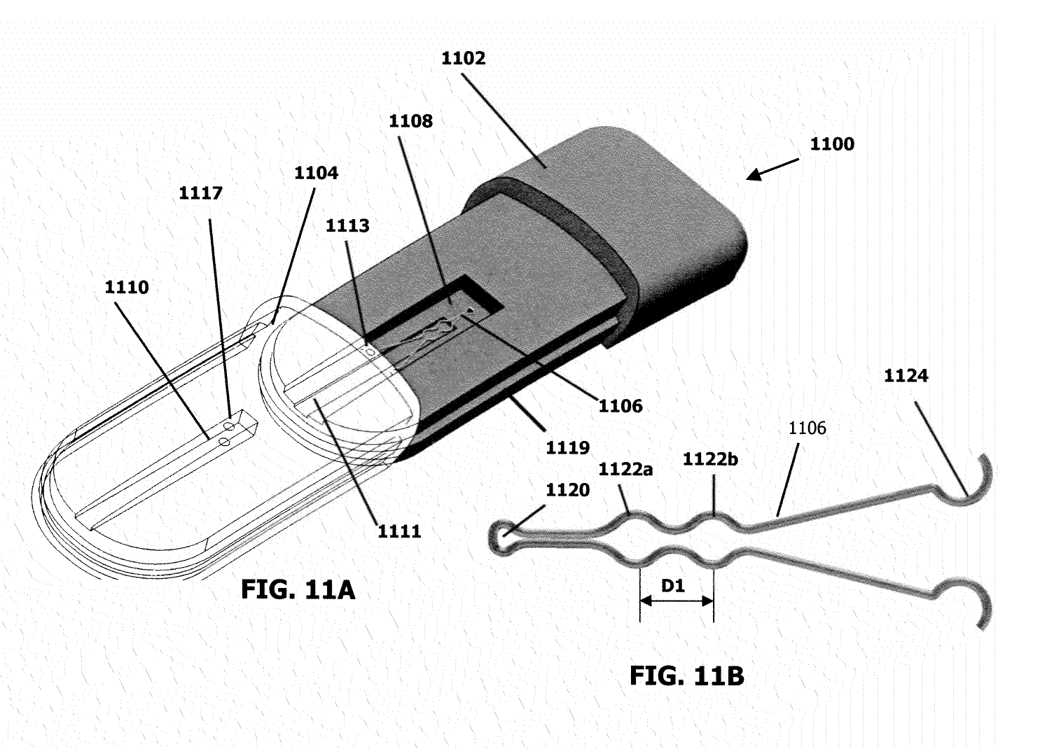

FIG. 11 illustrates another example of a retaining mechanism to allow movement of one housing part with respect to another housing part in a bi-stable manner. In one embodiment, the bi-stable mechanism comprises a hair needle spring 1106 that is secured in between the housing parts 1102 and 1104 of the device 1100. The spring 1106 is secured in a corresponding cavity 1108 to the housing part 1102. The spring 1106 can be secured to the housing part 1102 in any suitable fashion, including using an anchor through anchoring point 1120 shown in FIG. 3B. The housing part 1104 can include a guiding member 1110 that is received in a corresponding channel 1111 in the other housing part 1102. As the housing part 1104 is moved towards the housing part 1102, a post member 1117 engages one of the retaining portions 1122a and 1122b of the spring 1106. The retaining portions 1122a and 1122b are configured to releasingly retain the housing part 1104 is a certain position with respect to the other housing part 1102. As shown in FIG. 11B, in one embodiment, the sliding distance D1 of the housing parts 1102, 1104 between retaining portions 1122a and 1122b is approximately 4 millimeters. In alternate embodiments, the sliding distance D1, can be any suitable distance, such as for example, in the range of approximately 1 to 12 millimeters. As shown in FIGS. 11A and 11B, in one embodiment, if the housing part 1104 is moved beyond the sliding distance D1, a pair of post members 1113 can engage corresponding hooked portions 1124 of the spring 1106 to keep the housing part 1104 from becoming inadvertently disengaged or separated from the housing part 1102. The housing part 1102 can include one or more sliding members 1119 that are received in corresponding portions or channels of the housing part 1104.

The aspects of the disclosed embodiments allow for the movable element, in this example, back cover 204, to be moved, or slided, between the closed and open positions, with a one-handed control or movement. For example, when holding the device 200 in the right hand, the index finger (and other forefingers) will generally be in contact with the back surface 203 or the back cover 204, while the thumb will be in contact with the top surface 201 of the main body. Urging the thumb in one direction, such as direction A, and urging the index and forefingers in the opposite direction, such as direction B, will exert corresponding pressures on the main body 202 and back cover 204. Once a certain degree of pressure is exerted and maintained, the sliding mechanism will release the back cover 204 and allow the back cover 204 to move relative to the main body 202. In one embodiment, a force sufficient to overcome the resistance of the stop mechanism is needed to move the respective covers. This movement will result in the open or closed state as described herein. Urging the main body 202 in direction A and the back cover 204 in direction B, as shown in FIG. 2A, will result in the open state of the device 200 as shown in FIG. 2B. In one embodiment, the relative position of the main body 202 will remain stationary, while the back cover 204 moves in the direction B.

In order to unlock the device 200 or answer a call, the device 200 can be easily manipulated with one hand to obtain the desired function or result. For example, when the device 200 is in the closed state as shown in FIG. 2A, and an incoming call is detected, the simplified movement of the back cover 204 in the direction B, will engage the open state, and automatically answer the call. This provides the advantage that the monoblock device 200 can be manipulated with one hand to answer the call. This can be especially advantageous when the device 200 includes a touch screen display. In some instances, it may be difficult to see certain features presented on the screen of a touch screen display in direct or bright lighting conditions. In the typical device, it could be difficult to see the “answer” key when an incoming call is being received. However, with the monoblock device 200 of the disclosed embodiments, it is not necessary to be able to visualize features presented on the display. Rather, to answer a call, it is only necessary to move the back cover 204 from the closed position to the open position. Similarly, one does not have to look at the screen of the monoblock device 200 to determine if the device 200 is locked or unlocked. The position of the back cover 204 with respect to the main body 204 will identify whether the device 200 is in the locked or unlocked state.

In the closed position as shown in FIG. 2A, the keypad 206 and other devices/functions of the device can be “locked”, as that mode is generally known and understood. For example, in the “locked” mode, the device 200 is generally configured to allow for call handling functions, such as the notification and receipt of incoming calls or messages, but not enable the keypad 206 or multifunction device 208.

To unlock or operate the device 200 once it is “locked”, the back cover 204 is moved or “slided” to the open position as shown in FIG. 2B. This movement of the back cover 204 causes activation of the unlock function of the device 200, and the components and functions of the device 200 will be active. Moving the back cover 204 to the closed position as shown in FIG. 2A, will cause the device 200 to activate the “lock” function of the device 200.

The movement of the back cover 204 with respect to the main body 202 can also be used to answer incoming calls. Typically, in monoblock phones, a specific key must be pressed to answer an incoming call. In a flip style phone, the phone is “opened” to answer an incoming call. The aspects of the disclosed embodiments provide for answering an incoming call in the monoblock device 200 by sliding the back cover 204 with respect to the main body 202 to the “open” position.

In one embodiment, referring to FIG. 2B, movement of the back cover 204 away from the main body 202 to the open or unlocked position, can also open or expose a lower portion or section of the main body 202 to enable access to other functions of the device 200, such as for example, a microphone 214 for the device 200. As shown in FIG. 2C, the movement of the back cover 204 to the open position exposes a camera lens 216. In alternate embodiments, other suitable components of the device 200 can be protected by the back cover 204 when the back cover 204 is in the closed position, and exposed when the back cover 204 is in the open position. Examples of such devices can include, but are not limited to, USB ports, charging ports or connections, memory device slots, certain indicator lights, speaker or other suitable devices or components. In this respect, the back cover 204 can be utilized not only to hide these types of components from view, but also to protect these components from the unwanted intrusion of foreign particles, such as for example, dust and water. In this embodiment, the back cover 204 can be equipped with suitable gaskets to provide the components from these types of environmental effects. In one embodiment, the sliding back cover 204 can also be used to access the battery compartment, thus eliminating the need for a separate battery door.

In an embodiment where the device 200 comprises a media driven device, an audio element, such as a speaker or microphone can be located along either a top and/or bottom portion of the device 200, such as the microphone 214 shown in FIG. 2B. The movement of the sliding element can activate or enable a “media mode” of the device 200 as well as open or expose the area 212. In one embodiment, the area 212 is configured to be an enhanced audio area and can comprise, for example, a “cavity” or other such region that will enhance the audio environment of the media device 200. For example, the cavity 212 can be configured to provide more audio capture to provide an enhanced audio or speech signal to the microphone 214. Where the audio area 214 is a speaker, the audio area 214 can be configured to provide more back-volume and enable the speaker to provide a greater or enhanced sound. Although the area 214 is shown in FIG. 2B as extending from one side to the other side of the device 200, in alternate embodiments, the size and width of the area 212 can be limited.

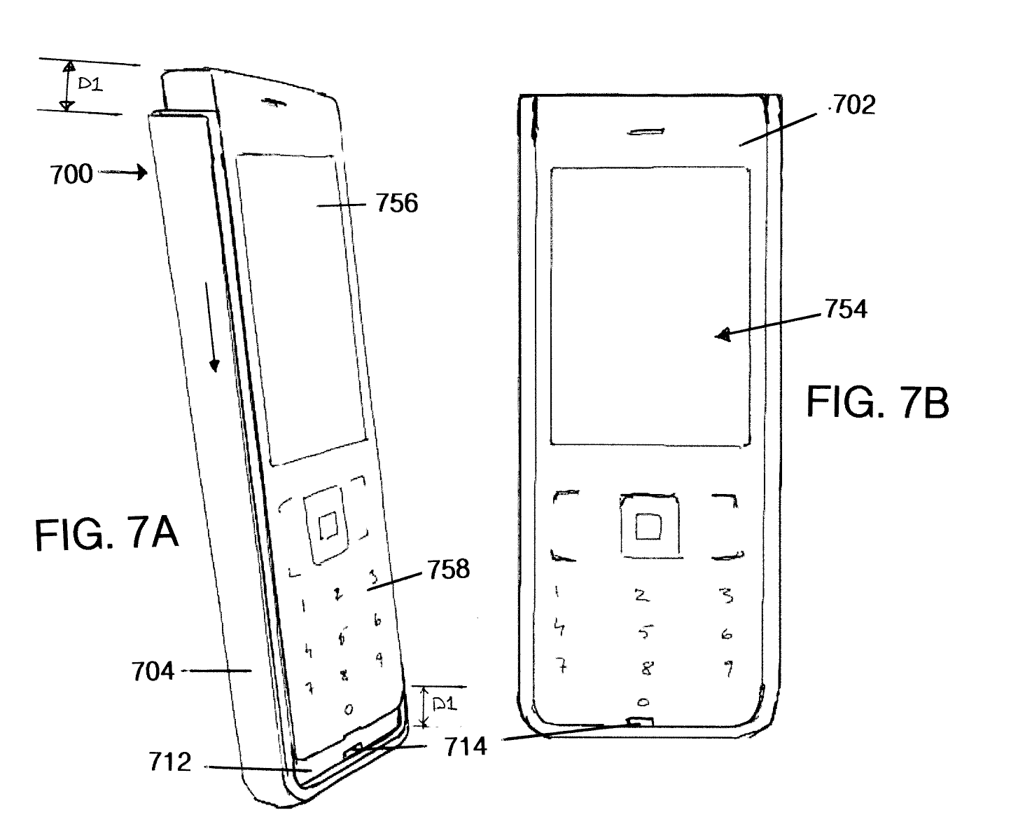

FIGS. 7A and 7B illustrate an example of a device 700 that includes an audio cavity area 712. In the closed position, as shown in FIG. 7B, a microphone opening 714 is integrated in the main body 702. As shown in FIG. 7A, when the device 700 is in the open position, the audio cavity area 712 is created by the separation between the main body 702 and the rear body portion 704. The audio cavity area 712 is generally configured to enhance the audio characteristics for the microphone. In one embodiment, the audio cavity area 712 can have any suitable or desired geometric configuration, as well as a dimension that generally corresponds to the sliding distance D1, referred to with respect to FIG. 11B.

Referring to FIG. 2B, when the device 200 is in the unlocked or open state, a bottom portion 218 of the back cover 204 extends beyond the original length of the device 200 in the closed state, and generally extends the overall length of the device 200. In the extended state, the separation 212 between the bottom portion 218 of the back cover 204 allows the bottom row of keys 220 to be accessed and manipulated more easily than before. The extended length of the device 200 provides ergonomic advantages, such as for example, adding more stability when operating the device 200 with one hand and exposing other components and elements of the device 200 that are otherwise hidden from view and protected. The positioning of the back cover 204 in the locked/unlocked state makes it easier to identify a state of the device and also provides other sensorial/emotional advantages and benefits.

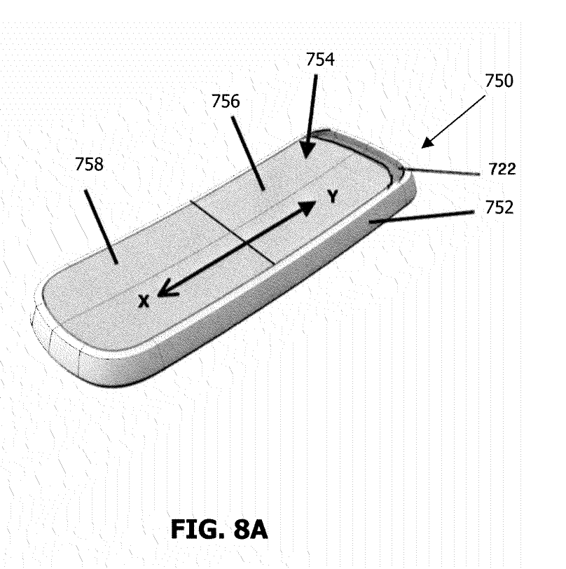

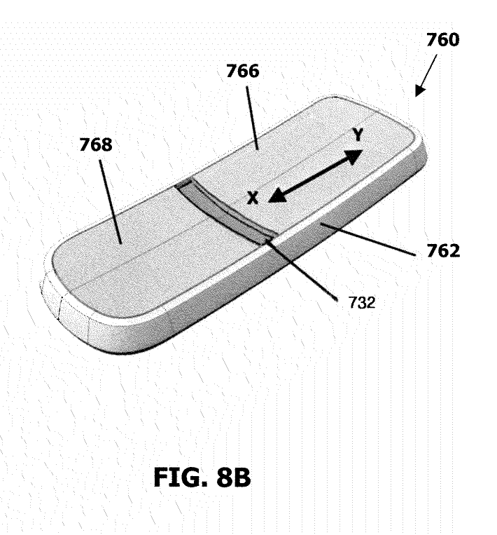

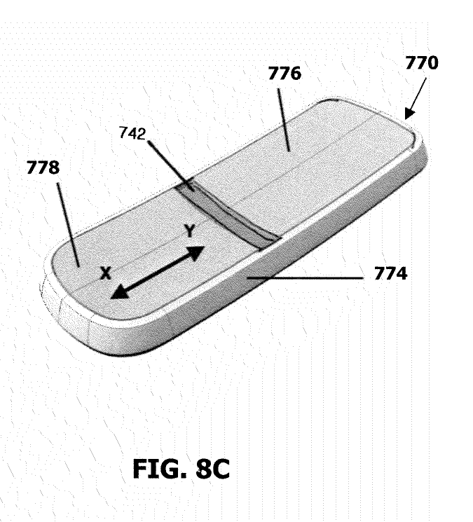

Although the movable element of embodiments disclosed herein are described with respect to the back cover of the device 200, in alternate embodiments, the movable element could comprise any suitable element of the device 200 that can be moved over a short distance, independently of the mechanical construction. For example, in one embodiment, the movable element can comprise the keypad or keymat of the device 200, the display of the device 200 or a combination thereof. For example, referring to FIG. 8A, the device 750 includes a display window area 756 and keypad area 758 within a housing 752. In this embodiment, the display window and keymat combination 754 is configured to slide or move in the X-Y direction, and when in the open position, forms gap 722. In FIG. 8B, the display window 766 and keypad 768 can be split, and the display window 766 of the device 760 is configured to move or slide between a first position and a second position in the X-Y direction relative to the housing 762. Gap 732 is formed in the open state. The keypad 768 will in this case, remain stationary relative to the housing 762. Referring to FIG. 8C, in this example, the movable element is the keypad 778, and the keypad 778 is configured to be movable between a first position and a second position along the X-Y direction. In this example, the display 776 remains stationary relative to the housing 772, with gap 742 between the two parts in the open state. In each case, the keypad, or in the case of a touchscreen device the touch area, can always remain visible, accessible and functional, even though the device is in the locked state.

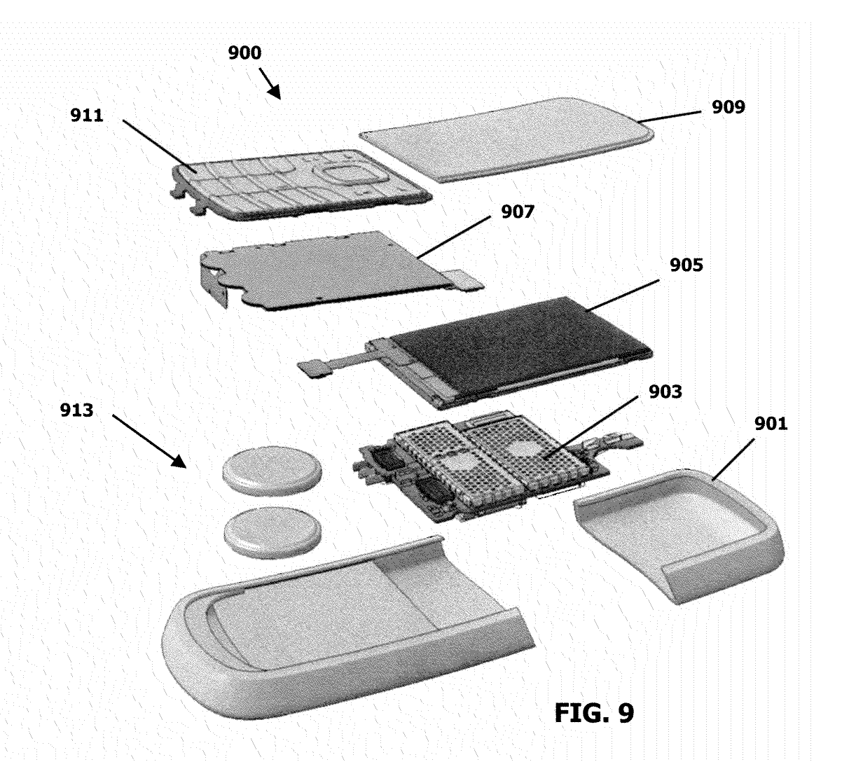

FIG. 9. illustrates an exploded view of the device 750 shown in FIG. 8A. The assembly 900 generally comprises a sliding cover 901 and the components that are mounted within the cover. As shown in FIG. 9, the assembly 900 includes a engine 903 and one or more batteries 913. The engine 903 generally comprises the processing modules and architecture described herein. A display 905 is coupled to the engine 903 over which a window 909 is mounted. A key mat 911 is located adjacent to the window 909, over the dome sheet 907.

Generally, the system 100 of FIG. 1 includes at least one user interface 106, process modules 122, application(s) module 180, and memory or storage device(s) 182. In alternate embodiments, the system 100 can include other suitable systems, devices and components that allow for using a sliding or movable element of a monoblock device to transition the device between a closed (non-active/locked) and open (active/unlocked) state. The components described herein are merely exemplary and are not intended to encompass all components that can be included in the system 100. The devices described with respect to the system 100 can also include one or more processors or computer program products to execute the processes, methods, sequences, algorithms and instructions described herein.

The user interface 106 generally comprises one or more input devices 104 and output devices 106. The input device(s) 104 are generally configured to allow the input of data, instructions, information gestures and commands to the system 100. The input device(s) 104 can include devices such as, for example but not limited to, keys or keypad 110, touch sensitive area or proximity screen 112, a mouse or pointing device 124 and data or image capturing device(s) (e.g. camera) 126. In one embodiment, the keypad 110 can be a soft key or other such adaptive or dynamic device of a touch screen 112. The input device 104 can also be configured to receive input commands remotely or from another device that is not local to the system 100. In alternate embodiments the input device 104 can comprise any suitable device(s) or means that allows or provides for the input and capture of data, information and/or instructions to a device, as described herein.

The output device(s) 106 are generally configured to allow information and data to be presented to the user via the user interface 102 of the system 100 and can include one or more devices such as, for example, a display 114, audio device 115 and/or tactile output device 116. In one embodiment, the output device 106 can also be configured to transmit information to another device, which can be remote from the system 100. While the input device 104 and output device 106 are shown as separate devices, in one embodiment, the input device 104 and output device 106 can comprise a single device, such as for example a touch screen device, and be part of and form, the user interface 102. For example, in one embodiment where the user interface 102 includes a touch screen device, the touch sensitive screen or area 112 can also provide and display information, such as keypad or keypad elements and/or character outputs in the touch sensitive area of the display 114. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. As described herein, the process module 122 is generally configured to detect a position of the sliding or movable element, in this example the back cover 204, relative to the main body 202 and activate either the inactive or active state of the device 220, depending upon whether the back cover 204 is in the closed or open state, respectively. In one embodiment, the process module 122 includes a movable element position determination module 136 and a device state module 138. In alternate embodiments, the process module 122 can include any suitable function or application module(s) that utilize a detected position of the back cover 204 relative to the main body, to establish the state of the device 200, as is described herein.

In one embodiment, the movable element position determination module 136 is configured to identify whether the back cover 204 is in an open or closed position relative to the main body 202. The movable element position determination module 136 can include, or be coupled to switch 322 shown in FIG. 3. The state of the switch 322 can be used by the movable element position determination module 136 to determine whether the back cover 204 is in the open or closed position.

The device state module 138 is generally configured to set a state of the device 200, depending in whether the back cover 204 is in the open or closed position. If the back cover 204 is in the closed position, the state of the device 200 will be set to the “locked” or “inactive” state, as the terms are known and described herein. If the back cover 204 is in the open position, the state of the device 200 will be set to the “unlocked” or “active” state, as those terms are generally known and described herein.

In one embodiment, the device state module 138 is also configured to allow a transition of the device 200 from the inactive to active state to enable call handling. If the device 200 is in the inactive state and an incoming call is detected, a transition of the back cover 204 from the closed position to the open position, as determined by the movable element position module 136, will allow the call to be automatically answered. Similarly, if the back cover 204 is moved from the open position to the closed position during a call, the call will be terminated.

Each of the movable element position module 136 and the state module 138 are configured to receive and transmit information to and between each other and each of the other devices, module and components of the system 100. Each module can include its own processor(s) and computer readable storage medium for carrying out and executing the processes described herein.

The application process controller 132 shown in FIG. 1 is generally configured to interface with the applications module 180 and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers, global positioning applications, navigation and position systems and locations and map applications. In alternate embodiments, the applications module 180 can include any suitable application that can be used by or utilized in the processes described herein.

The communication module 134 shown in FIG. 1 is generally configured to allow the device to receive and send communications and messages, such as location and position data, navigation information, text messages, chat messages, multimedia messages, video and email, for example. The communications module 134 is also configured to receive information, data and communications from other devices and systems or networks, such as for example, the Internet. In one embodiment, the communications module 134 is configured to interface with, and establish communications connections with other services and applications using the Internet.

In one embodiment, the applications module 180 can also include a voice recognition system that includes a text-to-speech module that allows the user to receive and input voice commands, prompts and instructions, through a suitable audio input device.

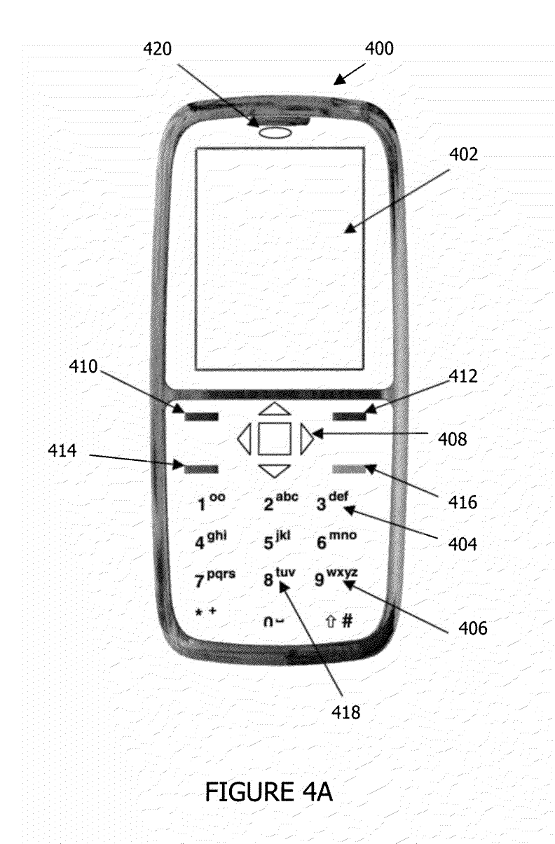

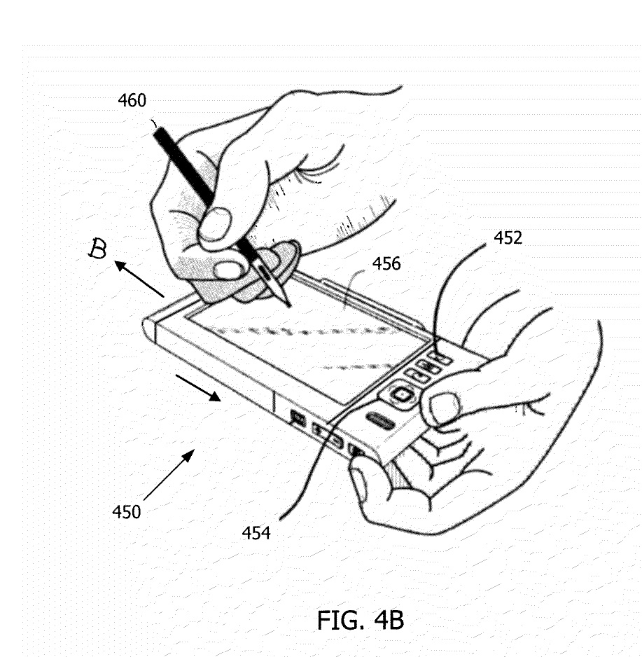

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and a touch sensitive area 404. As noted herein, in one embodiment, the display area 402 can also have touch sensitive characteristics. Although the display 402 of FIG. 4A is shown being integral to the device 400, in alternate embodiments, the display 402 may be a peripheral display connected or coupled to the device 400.

In one embodiment, the touch sensitive area 404 can include keypad 406 as an input device. The keypad 406, in the form of soft keys, may include any suitable user input functions such as, for example, a multi-function/scroll key 408, soft keys 410, 412, call key 414, end key 416 and alphanumeric keys 418. The keypad 406 can also be in the form of the keypad 110 of FIG. 1. In one embodiment, referring to FIG. 4B., the touch screen area 456 of device 450 can also present secondary functions, other than a keypad, using changing graphics.

As shown in FIG. 4B, in one embodiment, a pointing device, such as for example, a stylus 460, pen or simply the user's finger, may be used with the display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 400 can include an image capture device such as a camera 420 as a further input device. The device 400 may also include other suitable features such as, for example a loud speaker, tactile feedback devices or connectivity port. The device 400 may have a processor or other suitable computer program product (not shown) connected or coupled to the display for processing user inputs and displaying information on the display 402 and touch sensitive area 404. A computer readable storage device, such as a memory may be connected to the processor for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as a processor(s) and memory(s). In one embodiment, these devices will be Internet enabled and include GPS and map capabilities and functions.

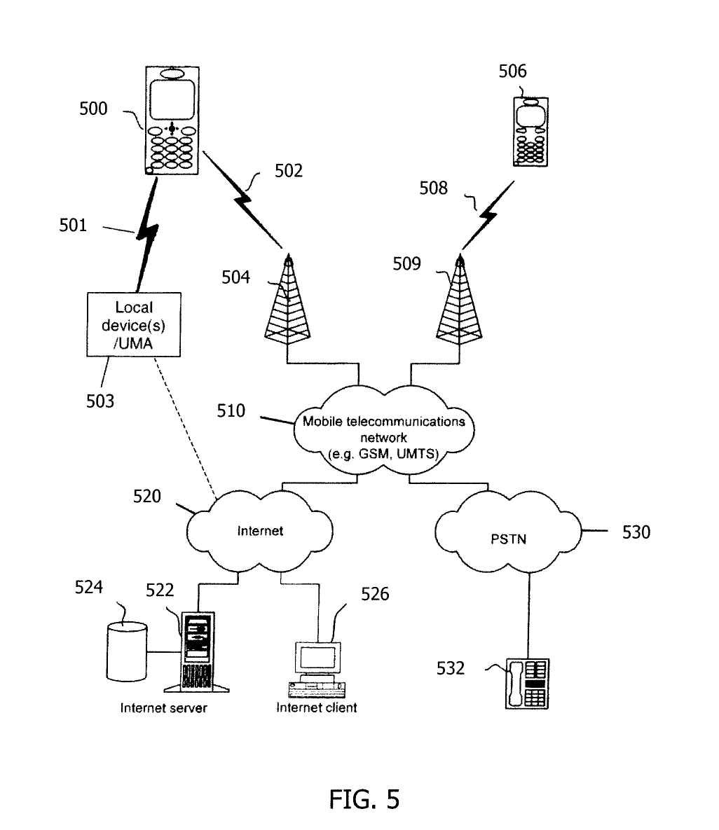

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the process modules 122 of FIG. 1 include communication module 134 that is configured to interact with, and communicate with, the system described with respect to FIG. 5.

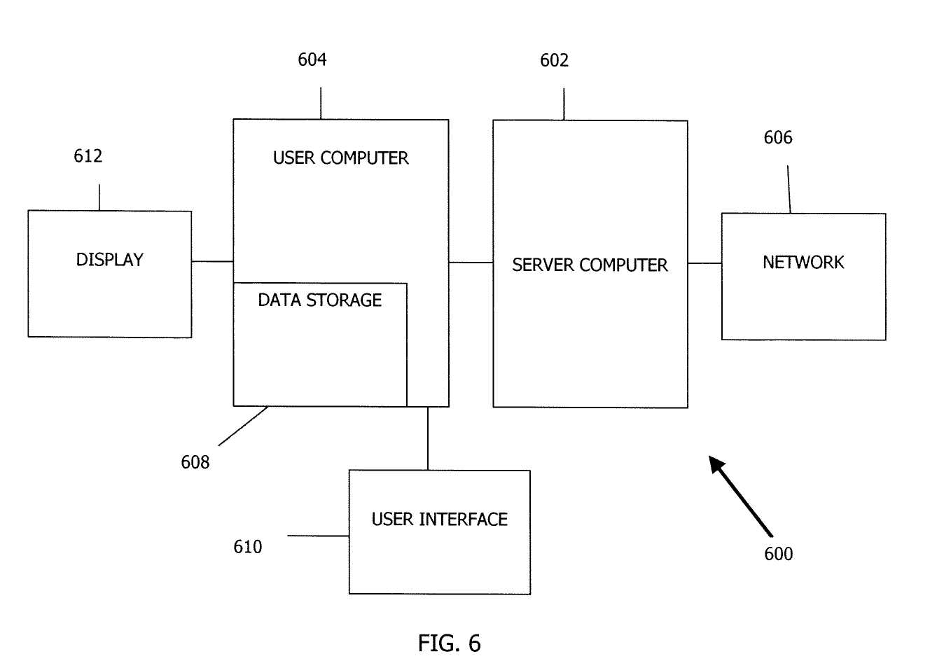

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, such as the position of the movable element, as well as present the results of the commands and queries, as described with reference to FIG. 1, for example.

The aspects of the disclosed embodiments add a physical transformation to a monoblock device that provides for a quick and easy way to lock and unlock the device, and handle calls. By configuring an element of the device to move or slide between two positions, the transformation from a closed position or inactive state to an open position or active state can be accomplished quickly and with one hand. The state of the device is easily identified by the position of the movable element with respect to the main body of the device.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a device body; and
an element of the device body that is movably engaged with the device body, the element being movable in a longitudinal direction between an open position and a closed position relative to the device body, wherein moving the element from the closed position to the open position engages an active state of the apparatus.

2. The apparatus of claim 1 wherein moving the element from the closed position to the open position comprises moving the element away from the device body in the longitudinal direction.

3. The apparatus of claim 1 further comprising a switch in the device body that is configured to detect whether the element is in the open position or closed position relative to the device body.

4. The apparatus of claim 1 further comprising that when the element is in the closed position, the apparatus is in a locked state.

5. The apparatus of claim 1 wherein the active state corresponds to an unlocked, call handling state of the apparatus.

6. The apparatus of claim 1 wherein the device body further comprises a top surface on which a plurality of keys are mounted.

7. The apparatus of claim 1 further comprising a microphone mounted in the device body, the microphone being covered by an end portion of the element when the element is in the closed position and uncovered when the element is in the open position.

8. The apparatus of claim 1 further comprising that the element is configured to be releasingly retained in each of the open and closed positions.

9. The apparatus of claim 1 further comprising that a call answer state of the apparatus is engaged when the element moves from the closed position to the open position.

10. The apparatus of claim 1 further comprising that the apparatus is monoblock communication device.

11. The apparatus of claim 1 further comprising a longitudinal retaining member on each side of the device body, each longitudinal retaining member configured to slidingly engage a corresponding longitudinal retaining member on each side of the element.

12. The apparatus of claim 1 wherein the element is a back cover, a keypad or display of the device.

13. A method comprising:
detecting a repositioning of a movable element of a monoblock communication device from a closed position to an open position; and
if a call is incoming, automatically answering the incoming call.

14. The method of claim 13 further comprising detecting a repositioning of the movable element of the device from the open position to the closed position and terminating the call.

15. The method of claim 13 further comprising:
engaging an active, unlocked state of the device when detecting the repositioning of the movable element from the closed position to the open position; and
engaging an inactive, locked state of the device when detecting a repositioning of the movable element from the open position to the closed position.

16. A method comprising:
detecting a repositioning of a movable element of a monoblock communication device from a closed position to an open position;
engaging an active, unlocked state of the device when detecting the repositioning of the movable element from the closed position to the open position; and
engaging an inactive, locked state of the device when detecting a repositioning of the movable element from the open position to the closed position.

17. The method of claim 16 further comprising activating a call handling function upon detecting a repositioning of the movable element from either the closed to open position or open to closed position.

18. A computer program product comprising a computer readable storage medium configured to execute the method according to claim 13 when implemented on a device including at least one processor.

19. A monoblock portable communication device comprising:
a main body and a back cover, the back cover slidingly engaging the main body along each lateral side of the main body in a longitudinal direction;
a switching device in the main body configured to detect a first position and a second position of the back cover relative to the main body;
wherein the first position comprises the back cover being moved in a linear fashion against the main body, the first position engaging a locked and inactive state of the device; and
the second position comprises the back cover being moved away in a linear fashion from the main body, the second position engaging an unlocked and active state of the device.

20. The monoblock device of claim 18 wherein moving the back cover away from the main body to the second position opens a section of the main body to expose a cavity including an audio device.
